(19) United States
(12) Patent Application Publication
(10) Pub. No.: US 2022/0158902 A1
(43) Pub. Date: May 19, 2022

(54) APPARATUS WITH NETWORK COMPONENT HAVING AT LEAST TWO SELECTABLE MODES OF OPERATION

(71) Applicant: Phoenix Contact GmbH & Co. KG, Blomberg (DE)

(72) Inventors: Gerrit BOYSEN, Detmold (DE); Andreas FUSS, Berlin (DE); Ingo HILGENKAMP, Rietberg (DE)

(21) Appl. No.: 17/439,319

(22) PCT Filed: Feb. 27, 2020
(86) PCT No.: PCT/EP2020/055126

§ 371 Date: Sep. 14, 2021

(30) Foreign Application Priority Data
Mar. 22, 2019 (LU) LU101164

(51) Int. Cl. H04L 41/0816

(52) U.S. Cl. CPC H04L 41/0816

(57) ABSTRACT

A mode-of-operation switching method for a network component for a network, which network component has a plurality of digital signal input connections and a mode-of-operation switching functionality for switching between at least two different modes of operation of the network component. The method can be used to temporarily selectively switch from a first preconfigured mode of operation to the at least one further mode of operation of the network component by at least temporarily switching a signal onto at least one predetermined digital signal input connection. Further, an apparatus having an accordingly adapted network component.

### FIELD

The present invention relates to a mode-of-operation switching method by means of which it is possible to switch to a selected mode of operation of a network component; a network component for a network, which network component has a mode-of-operation switching functionality for switching between at least two different modes of operation, i.e. the network component, in particular an Ethernet network component, can be operated in at least two different modes of operation; and an apparatus having an accordingly adapted network component.

### BACKGROUND

In the OT field, i.e. the field of operational technology, in which it is necessary to detect or bring about a change through direct monitoring and/or control of physical devices, processes and events in the company by means of hardware and software, it is known that remote maintenance and security routers have a mode-of-operation switching functionality so that they can be operated either in BRIDGE mode or in ROUTER mode. In bridge mode, the router is also generally not visible in the network, and therefore the bridge mode is in this case often referred to as GHOST mode or STEALTH mode. The switch to the GHOST mode or STEALTH mode is generally activated via a special, device-specific and computer-supported menu. Apart from this, remote maintenance and security routers from the OT field often also offer the option, regardless of the active mode of operation, to set up or disassemble a VPN tunnel by setting a digital input on the device (e.g. by turning a key switch), or to switch between firewall rule sets (conditional firewall).

However, in the office IT world or the consumer world, i.e. in the context of the world of office information technology, the GHOST or STEALTH mode is unusual in network components.

If the network component, and in particular the Ethernet network component, is delivered from the factory in stealth mode and the customer tries to access the web-based management (WBM) of the device in the same manner as he knows from his private home router, for example, this access must be carried out differently than with a conventional router as a result of the stealth mode. If, however, the network component is delivered in router mode, the customer must, in order to switch to stealth mode, open the web-based management and first configure the device accordingly.

### SUMMARY

The problem addressed by the invention is therefore that of providing a network component for a network that ensures a technically simple way of switching between at least two modes of operation.

The problem addressed by the invention is already solved by an Ethernet network component having the features of claim 1 and by a switching method having the features of claim 8.

Within the context of the invention, networks can, by definition, be communication, installation and/or computer networks, can in and of themselves represent private networks or public networks and can each form, for example, what are known as LANs (local area networks) or WANs (wide area networks), depending on the definition, as well as have a fundamentally different technical structure. Networks can consequently also cover a complete automation installation, production installation or office environment or even parts thereof, right up to individual network cells. Other examples include, for example, data centers or a public telephone network. Network devices connected within a network can, however, communicate with one another via a common medium and protocol and/or exchange data and can usually also share a number of resources. In the case of automation or production installations, for example, the network participants connected within a network communicate with one another, for example via a common Ethernet network.

According to the invention, an apparatus is therefore provided comprising a network component, in particular an Ethernet network component, for a network, which network component has a plurality of digital signal input connections and a mode-of-operation switching functionality for switching between at least two different modes of operation of the network component, wherein one of the modes of operation is preconfigured, and wherein the network component is designed to activate the switching from the preconfigured mode of operation to another mode of operation, specifically in response to a signal being at least temporarily switched onto at least one predetermined digital signal input connection.

A mode-of-operation selection device that interacts with the mode-of-operation switching functionality is expediently also comprised, for at least temporarily switching the signal onto at least one predetermined digital signal input connection in order to activate the switching from the preconfigured mode of operation to another mode of operation.

A significant advantage here is that, even during (initial) start-up, the network component can in principle, without access to an individual computer-supported switching or selection menu, be switched and set to a desired, in particular application-specific, mode of operation, on the basis of at least two selectable modes of operation.

It is particularly expedient for the mode-of-operation selection device to be designed to temporarily and directly electrically connect an operating voltage connection of the network component to the predetermined digital signal input connection.

In one embodiment, the preconfigured mode of operation of the at least two different modes of operation is a router mode of operation, and a second mode of operation of the at least two different modes of operation is intended for hiding the network component in the network.

The invention also proposes a mode-of-operation switching method, in particular for a network component of this kind, which method can be used to temporarily selectively switch from a first preconfigured mode of operation to at least one further mode of operation of the network component by at least temporarily switching a signal onto at least one predetermined digital signal input connection.

In one embodiment, an at least temporary switch is made from a preconfigured router mode of operation to a mode of operation for hiding the network component in the network as the selected mode of operation.

The network component is also expediently an Ethernet network component, and can therefore be used in a variety of ways. Additionally and/or alternatively, the mode-of-operation switching method according to the invention is designed in particular for Ethernet network components, and can therefore also be used in a variety of ways.

In principle, in one embodiment, the mode-of-operation selection device is designed as a DIP switch (DIP=dual in-line package) for switching a signal onto the at least one predetermined digital signal input connection. In this case, for example, switching the switch from one position into the other position can cause a particular mode of operation to transition from an activated state to a deactivated state. The mode-of-operation selection device can also have an SD memory card (secure digital memory card) which, depending on whether it is inserted or not, causes the switching to a mode of operation accordingly selected by the SD card to be activated/deactivated. In an alternative embodiment, a button for activating a selected mode of operation can also be provided.

In a particularly preferred embodiment, the mode-of-operation selection device has at least one wire bridge for directly temporarily connecting the at least one predetermined digital signal input connection to a signal source.

In particular, this eliminates the need for a further optical display, as may be the case with a button in which it is not readily apparent which operating mode the network component is in, and/or eliminates the need for a mode-of-operation selection device that is significantly more complex in terms of technology, e.g. a DIP switch or an SD card.

As an additional or alternative development of the particularly preferred embodiment, the mode-of-operation selection device has at least one, preferably a plurality of plugs, by means of which it is possible to individually selectively switch to different modes of operation, e.g. in each case using a predetermined wire bridge.

In a further embodiment, the mode-of-operation selection device additionally has a control device for temporarily switching a plurality of signals onto a plurality of predetermined digital signal input connections of the plurality of digital signal connections.

### BRIEF DESCRIPTION OF THE DRAWINGS

Further advantages and features of the invention are apparent from the following description of some preferred embodiments with reference to the accompanying drawings, in which:

FIG. 1 is a greatly simplified view of an embodiment of an apparatus comprising a network component according to the invention, in which apparatus the mode-of-operation selection device has at least one plug and a plurality of different plugs within the scope of a preferred embodiment of a mode-of-operation switching method, and

FIG. 2 is a greatly simplified view of an embodiment of an apparatus comprising a network component according to the invention, which apparatus comprises a mode-of-operation selection device which also has a control device.

### DETAILED DESCRIPTION

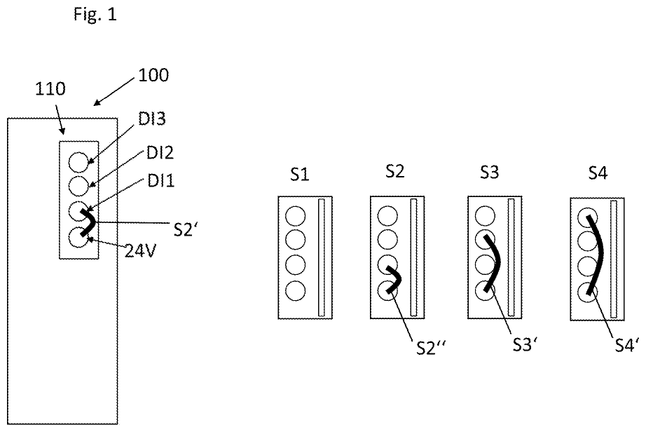

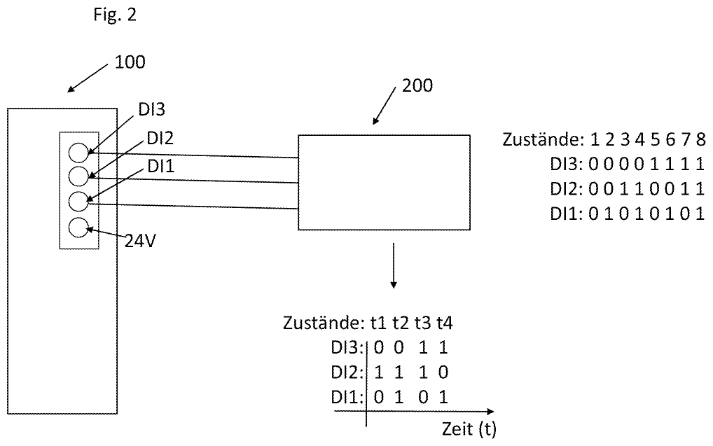

The following description of preferred embodiments of the invention is based on an apparatus shown as a whole in the greatly simplified views of FIGS. 1 and 2, with the reference sign 100 denoting a network component comprised by the apparatus for a network which is not shown in greater detail in the figures for the sake of simplicity. As is generally conventional and well known to a person skilled in the art, this network component has a plurality of digital signal input connections DI1, DI2 and DI3 and can be operated in at least two different modes of operation. The network component therefore also has a mode-of-operation switching functionality (not shown in greater detail in the figures for the sake of simplicity) for switching between the different modes of operation.

The network component 100 also has an operating voltage connection, denoted in the figures by 24V, which is expediently designed as an Ethernet network component so that it can be used in many ways and in particular also in the office IT world or the consumer world, i.e. in the context of the world of office information technology.

A mode of operation in which the network component can be operated is expediently designed, as is known in particular from remote maintenance and security routers, to hide the network component in the network, i.e. the network component is not visible in the network when the network component is operated in this mode of operation. A further mode of operation provides, for example, a mode of operation in which the network component can be operated in a router mode. Since the aforementioned configurations are substantially familiar to a person skilled in the field of network technology, these are not set out in greater detail below and are also not explicitly shown in the figures for reasons of clarity.

For the following description, it is also assumed that one of the at least two different modes of operation in which the network component can be operated is preconfigured, i.e. the preconfigured mode of operation is the one in which the factory-supplied network component starts operation when it is initially started up as intended.

According to the invention, the network component is designed in such a way that, in response to a signal being at least temporarily switched onto at least one predetermined digital signal input connection of the plurality of digital signal input connections DI1, DI2 and DI3, the switching from the preconfigured mode of operation to another operating mode is activated.

For this purpose, the apparatus expediently comprises at least one mode-of-operation selection device S2, S2′ which is assigned or can be assigned to the network component 100 and is shown next to the network component 100 in FIG. 1 for the sake of clarity. In a practical embodiment, in order to operate the network component in the possible, i.e. at least two different, modes of operations, the mode-of-operation selection device S2, S2′ is designed to select a desired mode of operation. In other words, the mode-of-operation selection device S2, S2′ interacts with the mode-of-operation switching functionality in order to activate the switching from one mode of operation to another mode of operation. Since it is assumed that one of the at least two different modes of operation in which the network component can be operated is preconfigured, the mode-of-operation selection device is designed at least to activate the switching from the preconfigured mode of operation to another mode of operation. Within the scope of the invention, for this purpose, the mode-of-operation selection device that interacts with the mode-of-operation switching functionality is designed to temporarily switch a signal onto at least one predetermined digital signal input connection.

If, according to an expedient design, the preconfigured mode of operation of the at least two different modes of operation is a router mode of operation, and a second mode of operation in which the network component can be operated is intended for hiding the network component in the network, the mode-of-operation selection device can at least temporarily switch a signal onto at least one predetermined digital signal input connection of the signal input connections DI1, DI2 and DI3 in order to activate the switching from the preconfigured router mode of operation to the mode of operation in which the network component is not visible in the network.

As can also be seen from the embodiment according to FIG. 1, the mode-of-operation selection device S2, S2′ for temporarily switching a signal is in this case expediently designed to temporarily and directly electrically connect the operating voltage connection 24V of the network component to at least one predetermined digital signal input connection. According to FIG. 1, the mode-of-operation selection device S2, S2′ is designed, for example, to temporarily and directly electrically connect the operating voltage connection 24V of the network component at least to the digital signal input connection DI1. In an expedient development, according to the invention the mode-of-operation selection device also has a wire bridge for directly temporarily connecting the at least one predetermined digital signal input connection to a signal source, and therefore in particular to the operating voltage connection 24V. This is shown in a greatly simplified manner in FIG. 1 by the mode-of-operation selection device denoted by S2′. The mode-of-operation selection device S2′ designed as a wire bridge is therefore, for example, designed and in particular formed to directly connect the digital signal input connection DI′ to the operating voltage connection 24V so as to conduct electricity. The mode-of-operation selection device S2′ designed as a wire bridge is in this case expediently formed such that one end of the wire bridge is intended to be inserted into the operating voltage connection 24V and the other end of the wire bridge is intended to be inserted into a predetermined signal input connection, i.e. for example into the signal input connection DI1. Alternatively, the mode-of-operation selection device can also be designed as a plug, as shown in a highly simplified manner in FIG. 1 by the mode-of-operation selection device denoted by S2, which can then be plugged, for example, onto or into a mating plug connector 110 of the network component that comprises the digital signal input connections DI1, DI2, DI3 and an operating voltage connection 24V together. The mode-of-operation selection device 2 designed as a plug is therefore also designed such that a predetermined mode of operation is selected by plugging the plug and the mating plug connector together. For this purpose, at least one predetermined signal input connection can expediently be connected to the operating voltage connection, which is advantageously used as a signal source, so as to conduct electricity. In order to be directly connected to one another so as to conduct electricity, the mode-of-operation selection device 2 designed as a plug can expediently contain a wire bridge S2″ which is designed and in particular formed accordingly for this purpose.

In particular if, according to a further expedient embodiment, the network component has a mode-of-operation switching functionality for switching between more than just two different modes of operation, e.g. between three or four modes of operation, the mode-of-operation selection device of the network component can also contain a corresponding plurality of wire bridges that are each designed and in particular formed differently accordingly, which wire bridges are each accordingly selected depending on the desired selection and are each suitable for connecting a particular signal input connection and the signal source, and therefore in particular the operating voltage connection, directly to one another so as to conduct electricity. Alternatively, however, a mode-of-operation selection device 2 designed as a plug can also be provided for this purpose, in which a plurality of differently designed and in particular formed wire bridges S2″, S3′, S4′ can each be individually at least temporarily received, i.e. in a removable manner, in order to directly connect another predetermined signal input connection to the operation voltage connection used as the signal source so as to conduct electricity.

Alternatively, the mode-of-operation selection device can also comprise a plurality of plugs S1, S2, S3, S4 which are each designed such that a predetermined mode of operation is selected by plugging together a particular plug and the mating plug connector. In a practical embodiment, if the mode-of-operation selection device therefore has a plurality of plugs by means of which it is possible to selectively switch to different modes of operation, in this case no plug is provided for selecting the preconfigured mode of operation, or a plug from the plurality of plugs S1, S2, S3, S4, in FIG. 1 the plug S1, is provided in particular for visual identification of this mode of operation, which plug expediently does not directly connect any signal input connection to the operating voltage connection, which is advantageously used as a signal source, so as to conduct electricity. For all other selectable modes of operation, one plug S2, S3 or S4 from the plurality of plugs S1, S2, S3, S4 can in turn be designed to directly connect at least one predetermined signal input connection to the operating voltage connection, which is advantageously used as a signal source, so as to conduct electricity. For this purpose, the plugs S2, S3 or S4 from the plurality of plugs S1, S2, S3, S4 can expediently contain a wire bridge S2″, S3′ or S4′, respectively, which is designed and in particular formed accordingly.

If the mode-of-operation selection device therefore has a plurality of differently designed wire bridges or plugs S1, S2, S3, S4, it is advantageous for these to therefore each be appropriately coded for a mode of operation to be selected.

The expedient developments relating to designing the mode-of-operation selection device such that it has a wire bridge or even a plurality of wire bridges, or such that it has a plug or a plurality of plugs, are also advantageous, for example by comparison with designing it as a button, in that the network component according to the invention is not connected to a voltage and ready for operation in order to carry out a switch relating to a selected mode of operation. If a button is used, the network component must be connected to a voltage and ready for operation in order to carry out the switching as a result of the button being pressed. In addition, if a button is used, a further optical display is required, since the user or customer of the network component cannot see which operating mode the network component is in after pressing the button, i.e. whether it is in the stealth or router mode of operation, for example. This is not required if at least one or one plug, since or more wire bridges are used, since these can also function as an optical display relating to the selected mode of operation.

Again by comparison with designing the mode-of-operation selection device using a DIP switch by means of which selected switching can be brought about by moving the DIP switch from a first position into a second position, the aforementioned expedient developments regarding the design of the mode-of-operation selection device are also advantageous, for example, in that they do not have to be “permanently installed in the device” as hardware. However, if the user or customer of the network component no longer needs to switch between different modes of operation in later operation, a DIP switch that is “permanently installed in the device” as hardware must remain there, even though it is not required for the entire product life cycle. This is wasteful and can be avoided by means of the expedient developments relating to designing the mode-of-operation selection device in such a way that it has a wire bridge or a plurality of wire bridges, or in such a way that it has a plug or a plurality of plugs, since these can also be reused e.g. with other network components, at least of the same type.

Again by comparison with designing the mode-of-operation selection device using an SD memory card, in which design switching between different modes of operation, e.g. between stealth and router modes of operation, takes place via an evaluation as to whether the SD memory card is inserted or not, and such an additional storage medium as a kind of “key” is always necessary and must be at hand, the simplicity of the aforementioned expedient developments relating to the design of the mode-of-operation selection device, in particular when using one or more wire bridges, is also advantageous in that a wire bridge can generally also be quickly installed if necessary.

In particular, if the mode-of-operation switching functionality is designed to switch between at least a large number of, e.g. more than four, different modes of operation and/or the switching between at least two different modes of operation is intended to take place frequently, the mode-of-operation selection device can, within the scope of the invention, additionally or alternatively also advantageously have a control device for temporarily switching a plurality of signals onto a plurality of predetermined digital signal input connections of the plurality of digital signal connections, which is shown in one embodiment in a greatly simplified manner in FIG. 2.

In a modification of FIG. 1, FIG. 2 shows an embodiment of a network component 100 comprising a control device 200 as the mode-of-operation selection device. The inside of the control device 200 contains a signal source (not shown in greater detail for the sake of simplicity) to which the digital signal input connections DI1, DI″ and DI3 are routed. The selected switching to a predetermined mode of operation takes place depending on onto which digital signal input a signal is switched or which digital signal input connection is temporarily electrically connected directly to the signal source, i.e. the digital state of the signal input connection to which such a signal is applied changing from 0 to 1.

As shown in FIG. 2, such a signal can consequently also be switched onto a plurality of digital signal input connections at the same time.

With such a control device 200 as a mode-of-operation selection device, for example, it is therefore possible, for example in the case of three signal input connections, for in principle eight different states for respectively selecting a predetermined mode of operation to be achieved, and it is thus possible to switch individually between eight different operating modes. The following table, which can also be found in FIG. 2, illustrates this.

| State | 1 | 2 | 3 | 4 | 5 | 6 | 7 | 8 |
|---|---|---|---|---|---|---|---|---|
| DI2 | 0 | 0 | 0 | 0 | 1 | 1 | 1 | 1 |
| DI2 | 0 | 0 | 1 | 1 | 0 | 0 | 1 | 1 |
| DI3 | 0 | 1 | 0 | 1 | 0 | 1 | 0 | 1 |

In state 1, taking the above description into account, the preconfigured mode of operation is expediently selected.

This embodiment also opens up the possibility of further coding over time, in order to switch extremely dynamically and/or switch selectively between further modes of operation.

It is also possible for a plurality of different states as described above to be used jointly over a predetermined period of time in order to respectively select a predetermined mode of operation, to which a switch is then made. In this case, the plurality of different states as described above are expediently present at fixed time intervals, i.e. a different state is set at each fixed time interval by switching one or more signals onto one or more digital signal input connections. This is because it can be easily recognized whether coding takes place over time or not. If there is no change of state in these at fixed time intervals and/or in this predetermined period of time, there is therefore no coding taking place over time.

The following table, which can also be found in FIG. 2, again illustrates the coding over time. Correspondingly, it is assumed in this case that the times t1, t2, t3 and t4 at which a different state, for example in the case of three signal input connections in principle eight different states, is specified by means of the control device 200 as the mode-of-operation selection device, follow one another within fixed time intervals.

If there is coding over time, the final state for selecting a mode of operation that is predetermined in accordance therewith results from the combination of the states present at the times t1 to t4.

Taking into account the preceding description, using the apparatus according to the invention and applying the method according to the invention for example during (initial) start-up of a network component as described above, the product-specific firmware contained therein can query the state of the digital input. If a signal is applied to a digital input, for example by means of the wire bridge S2′ according to FIG. 1, the device is started up e.g. in the stealth mode of operation, and the network component is therefore not visible in the network, in particular the Ethernet network, and also expediently protects any further network components in the network “behind” the network component by means of a preconfigured profile. This is therefore a simple “Plug & Protect start-up mode” for the user or customer. If the user or customer removes the wire bridge or if there is no wire bridge at (initial) start-up, there is consequently no signal applied to the digital input. Accordingly, the network component is switched into the preconfigured mode of operation or the network component is started up in the preconfigured mode of operation, wherein. If, for example, a switch is made to the router mode of operation or start-up is carried out in this mode, the user or customer can now access the web-based management via a computer as usual and, if necessary, configure the network components individually. In the configuration panel, the customer then has the option, for example, of individually adapting or deactivating the preconfigured mode of operation and/or using the digital signal input connection for other functions.

### LIST OF REFERENCE SIGNS

100 network component,
DI1, DI2 and DI3 digital signal input connections,
24V operating voltage connection,
S1, S2, S3, S4 plug as mode-of-operation selection device,
S2′, S2″, S3′, S4′ wire bridge as mode-of-operation selection device,
110 mating plug connector,
200 control device as mode-of-operation selection device

1. An apparatus comprising:
a network component, in particular an Ethernet network component, for a network, which network component has a plurality of digital signal input connections and a mode-of-operation switching functionality for switching between at least two different modes of operation of the network component, wherein one of the modes of operation is preconfigured, and wherein the network component is designed to activate the switching from the preconfigured mode of operation to another mode of operation, specifically in response to a signal being at least temporarily switched onto at least one predetermined digital signal input connection.

2. The apparatus according to claim 1, further comprising:
a mode-of-operation selection device that interacts with the mode-of-operation switching functionality, for at least temporarily switching the signal onto at least one predetermined digital signal input connection in order to activate the switching from the preconfigured mode of operation to the other mode of operation.

3. The apparatus according to claim 2, wherein the mode-of-operation selection device is designed to temporarily and directly electrically connect an operating voltage connection of the network component to the predetermined digital signal input connection.

4. The apparatus according to either claim 2, wherein, of the at least two different modes of operation, the preconfigured mode of operation is a router mode of operation and a second mode of operation is intended for hiding the network component in the network.

5. The apparatus according to claim 2, wherein the mode-of-operation selection device has at least one wire bridge for directly electrically temporarily connecting the at least one predetermined digital signal input connection to a signal source.

6. The apparatus according to claim 2, wherein the mode-of-operation selection device has at least one, preferably a plurality of plugs by means of which it is possible to individually selectively switch to different modes of operation.

7. The apparatus according to claim 2, wherein the mode-of-operation selection device has a control device for temporarily switching a plurality of signals onto a plurality of predetermined digital signal input connections of the plurality of digital signal connections.

8. A mode-of-operation switching method for a network component for a network, which network component has a plurality of digital signal input connections and a mode-of-operation switching functionality for switching between at least two different modes of operation of the network component, for a network component according to claim 1, which method can be used to temporarily selectively switch from a first preconfigured mode of operation to the at least one further mode of operation of the network component by at least temporarily switching a signal onto at least one predetermined digital signal input connection.

9. The mode-of-operation switching method according to claim 8, wherein an at least temporary switch is made from a preconfigured router mode of operation to a mode of operation for hiding the network component in the network as the selected mode of operation.

10. The mode-of-operation switching method according to claim 8, wherein:
at least one wire bridge and/or at least one plug is used as the mode-of-operation selection device, by means of which the at least one predetermined digital signal input connection is temporarily electrically connected directly to a signal source in order to individually selectively switch between the different modes of operation,
and/or
wherein the mode-of-operation selection device has a control device for temporarily switching a plurality of signals onto a plurality of predetermined digital signal input connections of the plurality of digital signal connections.
